(19) United States
(12) Patent Application Publication
(10) Pub. No.: US 2009/0002520 A1
(43) Pub. Date: Jan. 1, 2009

(54) IMAGING APPARATUS, IMAGING METHOD, STORAGE MEDIUM STORING PROGRAM, AND INTEGRATED CIRCUIT

(76) Inventors: Norikatsu YOSHIDA, Hyogo (JP); Tadami Mine, Osaka (JP); Hideyuki Furuya, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/147,229

(22) Filed: Jun. 26, 2008

(30) Foreign Application Priority Data
Jun. 29, 2007 (JP) 2007-171926

(51) Int. Cl. H04N 9/73

(52) U.S. Cl. 348/226.1; 348/E09.051

(57) ABSTRACT

An imaging apparatus reduces flicker occurring under fluorescent lamp illumination in real time and also effectively reduces noise of a captured image generated by low-sensitive pixel areas fixed on an imaging surface. The imaging apparatus obtains a first image signal including no flicker element and a second image signal including a flicker element for each frame, and calculates a gain correction coefficient for eliminating the flicker element in the second image signal based on the first and second image signals, eliminates the flicker element from the second image signal based on the gain correction coefficient, and combines the first and second image signals to generate an image signal from which the flicker element has been eliminated. The imaging apparatus also effectively reduces noise of a captured image generated by low-sensitive pixel areas fixed on an imaging surface by changing the charge accumulation time of pixels depending on each frame.

### BACKGROUND OF THE INVENTION

1. Field of the Invention

The present invention relates to a technique for detecting and correcting a flicker phenomenon that occurs when an image is captured using an imaging apparatus including an XY-driving image sensor, such as a metal oxide semiconductor (MOS) image sensor, under illumination whose luminance varies depending on power supply frequencies.

2. Description of the Related Art

When an image is captured under illumination whose luminance varies depending on power supply frequencies, the captured image may have flicker, which needs to be detected and corrected. A typical imaging apparatus with a frame rate of 60 fps may have flicker under illumination of a power supply with a power supply frequency of 50 Hz. Flicker of such an imaging apparatus will now be described in detail with reference to FIG. 7. As shown in FIG. 7, an XY-driving image sensor of the imaging apparatus, such as a MOS image sensor, exposes different lines at different exposure timings. When the image sensor is driven with a certain exposure time, the lines of the image sensor accumulate different amounts of light. That causes horizontal lines of flicker, which are repeated every three frames, to occur on an image (video) captured by the imaging apparatus.

When the image sensor is driven with a charge accumulation time (exposure time) of 1/100 second, that is, when the image sensor is driven to expose for the time corresponding to half the cycle of the power supply frequency of the illumination, the lines of the image sensor all accumulate the same amount of light. In this case, the imaging apparatus captures an image (video) without horizontal lines of flicker. Based on this widely known fact, the image sensor is usually driven with the charge accumulation time (exposure time) of 1/100 second to eliminate flicker in a simple manner when flicker is detected under the illumination with the power supply frequency of 50 Hz.

In this case, however, the imaging apparatus is maintained in a low-sensitive state. More specifically, the charge accumulation time (exposure time) of the image sensor is fixed short. The image sensor obtains a video signal with a lower output level when the charge accumulation time is short, as compared with when the charge accumulation time of the image sensor is long. To increase the output level of a video signal obtained by the image sensor, the gain of the amplifier needs to be set large. However, increasing the gain of the amplifier would degrade the signal-to-noise (S/N) ratio of the video signal.

To detect flicker in a conventional imaging apparatus, an imaging unit may be driven with two different accumulation times for the first frame. The imaging unit may then be driven in a normal manner with one accumulation time for the second and subsequent frames. To correct flicker, the gain of an amplifier subsequent to the imaging unit is adjusted. For ease of explanation, the power supply frequency of the illumination used for the conventional imaging apparatus is assumed to be 50 Hz.

FIG. 8 shows correction of images captured by a conventional imaging apparatus with two different charge accumulation times.

The image sensor is assumed to be driven with the two different charge accumulation times ( 1/100 second and 1/60 second) to expose different lines of pixels with different charge accumulation times for the first frame (for example, pixels in odd vertical lines are exposed with the charge accumulation time of 1/100 second, whereas pixels in even vertical lines are exposed with the charge accumulation time of 1/60 second). In this case, an image signal A obtained with the charge accumulation time of 1/100 second will have no flicker, whereas an image signal B obtained with the charge accumulation time of 1/60 second will have flicker. The imaging apparatus then divides the image signal B by the image signal A. As a result, the subject images cancel out to generate an image signal C (=B/A), which has a luminance pattern corresponding only to the flicker element. The imaging apparatus also calculates an output waveform V of the vertically projected image signal C. The imaging apparatus also calculates a correction coefficient that is proportional to the phase opposite to the phase of the output waveform V. The imaging apparatus multiplies the image signal B, which is obtained with the charge accumulation time of 1/60 second, by the calculated correction coefficient to generate an image signal from which the flicker element is eliminated (corrected image signal).

FIG. 6 shows the overall structure of a conventional imaging apparatus 400.

The imaging apparatus 400 includes an imaging unit 401, an exposure time control circuit 402, a flicker detection circuit 403, a gain control circuit 404, and a gain variable amplifier 405. The imaging unit 401 converts light from a subject by photoelectric conversion to generate a video signal (image signal). The exposure time control circuit 402 outputs an exposure time control signal, which is used to control the exposure time of an image sensor of the imaging unit 401, to the imaging unit 401. The flicker detection circuit 403 detects flicker based on an image signal output from the imaging unit 401. The gain control circuit 404 determines a gain correction coefficient based on an output of the flicker detection circuit 403. Based on the gain correction coefficient, the gain variable amplifier 405 changes the gain to be multiplied by an image signal corresponding to the second or subsequent frame, which is output from the imaging unit 401. Although not shown, the imaging apparatus 400 further includes a central control unit that controls the operation of each unit, such as the operation timing of each unit.

The imaging unit 401 includes a pixel unit (image sensor), a vertical shift register, a first horizontal shift register and a first line memory, and a second horizontal shift register and a second line memory. The vertical shift register is assigned to all vertical lines of the pixel unit. The first horizontal shift register and the first line memory are assigned to odd vertical lines of the pixel unit. The second horizontal shift register and the second line memory are assigned to even vertical lines of the pixel unit. The pixels in the odd vertical lines of the pixel unit are driven with the charge accumulation time (exposure time) of n/100 second (n is a positive integer), with which no flicker is generated under a power supply illumination with a power supply frequency of 50 Hz. The pixels in the even vertical lines of the pixel unit are driven with the charge accumulation time (exposure time) of n/120 second (where n is a positive integer), with which no flicker is generated under a power supply illumination with a power supply frequency of 60 Hz.

The exposure time control circuit 402 outputs an exposure time control signal to the imaging unit 401. The exposure time control signal causes the pixels in the odd vertical lines of the pixel unit (image sensor) of the imaging unit 401 to be driven with one charge accumulation time and the pixels in the even vertical lines of the pixel unit to be driven with another charge accumulation time.

The flicker detection circuit 403 detects a flicker element based on an image signal corresponding to the first frame, which is output from the imaging unit 401, and provides (outputs) the detection signal to the gain control circuit 404.

The gain control circuit 404 calculates a gain correction coefficient corresponding to the correction gain that is proportional to the phase opposite to the phase of the flicker element detected by the flicker detection circuit 403. The gain control circuit 404 then outputs the gain correction coefficient to the gain variable amplifier 405.

When the flicker detection circuit 403 detects flicker in the image signal corresponding to the first frame, the gain variable amplifier 405 multiplies an image signal corresponding to the second or subsequent frame, which is output from the imaging unit 401, by the gain correction coefficient, which is output from the gain control circuit 404. Through this process, the gain variable amplifier 405 eliminates the flicker element from the image signal. The gain variable amplifier 405 then outputs the corrected image signal, from which the flicker element has been cancelled out (eliminated). When the flicker detection circuit 403 detects no flicker in the image signal corresponding to the first frame, the gain variable amplifier 405 outputs the image signal without flicker, which is output from the imaging unit 401, without processing the image signal.
Patent Citation 1: Japanese Unexamined Patent Publication No. 2006-245784 ([0030] to [0054])

### SUMMARY OF THE INVENTION

### Technical Problem

However, the above conventional imaging apparatus detects a flicker element of an image corresponding to only a single frame out of a plurality of frames, and calculates a gain correction value based on phase information associated with the detected flicker element. More specifically, the imaging apparatus detects a flicker element using one frame and corrects a flicker element of another frame. When, for example, the illumination changes with time in the image capturing environment or when the imaging apparatus is moved to alternately capture an image of an indoor scene and an image of an outdoor scene, the flicker correction performed by the conventional imaging apparatus would have errors. In other words, the conventional imaging apparatus fails to appropriately correct flicker in real time when the imaging unit is moved.

To solve the above problem, it is an object of the present invention to provide an imaging apparatus, an imaging method, a storage medium storing a program, and an integrated circuit for appropriately correcting flicker in real time even when an imaging apparatus (camera) is moved and also effectively reducing noise of a captured image generated by low-sensitive pixel areas that are fixed on an imaging surface.

### Technical Solution

A first aspect of the present invention provides an imaging apparatus including an imaging unit, a charge accumulation time setting unit, a switch unit, a drive unit, a signal switching unit, a first gain correction unit, a gain calculation unit, a second gain correction unit, and a signal combining unit. The imaging unit includes an image sensor having a first group of pixels and a second group of pixels that are driven independently of each other. The charge accumulation time setting unit sets, for an image that is formed by the imaging unit, a first charge accumulation time with which no flicker element is generated due to a power supply frequency of illumination and a second charge accumulation time different from the first charge accumulation time. The switch unit switches, for every frame, a charge accumulation time for the first group of pixels and a charge accumulation time for the second group of pixels between the first charge accumulation time and the second charge accumulation time. The drive unit drives the pixels included in the first group and the pixels included in the second group with the first charge accumulation time and the second charge accumulation time that are switched for every frame by the switch unit. The signal switching unit outputs an image signal obtained with the first charge accumulation time by the imaging unit as a first image signal, and outputs an image signal obtained with the second charge accumulation time by the imaging unit as a second image signal. The first gain correction unit performs gain correction to adjust a signal level of the first image signal to a signal level of the second image signal. The gain calculation unit calculates a gain correction coefficient for correcting a flicker element included in the second image signal based on the first image signal and the second image signal. The second gain correction unit corrects a flicker element included in the second image signal based on the gain correction coefficient. The signal combining unit combines the second image signal corrected by the second gain correction unit and the first image signal subjected to gain correction performed by the first gain correction unit in an arrangement identical to an arrangement of the first group of pixels and the second group of pixels in the image sensor.

This imaging apparatus obtains a first signal including no flicker element and a second image signal including a flicker element for each frame, and calculates a gain correction coefficient for eliminating the flicker element included in the second signal based on the first image signal and the second image signal. The imaging apparatus combines the first image signal and the second image signal after eliminating the flicker element from the second image signal based on the gain correction coefficient. As a result, the imaging apparatus generates an image signal from which the flicker element has been eliminated. The imaging apparatus further switches the charge accumulation time of the pixels between the first charge accumulation time and the second charge accumulation time for each frame. This prevents low-sensitive pixel areas (pixel areas consisting of pixels that are driven with a short charge accumulation time) from being fixed on the imaging surface.

As a result, even when the imaging apparatus is moved, the imaging apparatus appropriately corrects flicker in real time, and also effectively reduces noise of a captured image generated by low-sensitive pixel areas that are fixed on the imaging surface.

The term “combining the signals in an arrangement identical to an arrangement of the first group of pixels and the second group of pixels in the image sensor” refers to, for example, combining a first image signal output from the first gain correction unit and a second image signal output from the second gain correction unit according to the positional relationship of the first group of pixels and the second group of pixels in the image sensor when the first image signal is the image signal obtained from the first group and the second image signal is the image signal obtained from the second group. The resulting combined image signal, which is obtained by combining the above signals in the same arrangement as the arrangement of the first group of pixels and the second group of pixels, is displayed on a display unit. This enables an image captured by the image sensor of the imaging unit to be reproduced as a two-dimensional image in a precise manner.

The “flicker element” herein refers to a flicker element of an image captured by the imaging apparatus that can be generated due to the power supply frequency of the illumination arranged in the surrounding environment of the imaging apparatus.

A second aspect of the present invention provides the imaging apparatus of the first aspect of the present invention in which the gain calculation unit calculates an average value A of signal levels in every horizontal line of a first image that is formed using the first image signal, and an average value B of signal levels in every horizontal line of a second image that is formed using the second image signal, and calculates a ratio C of the horizontal line average values as C=A/B as the gain correction coefficient, and the second gain correction unit corrects the second image signal by multiplying the second image signal by the ratio C of the horizontal line average values calculated by the gain calculation unit.

This imaging apparatus effectively eliminates (corrects) the flicker element with a simple method.

A third aspect of the present invention provides the imaging apparatus of the first or second aspect of the present invention in which the imaging unit includes the image sensor in which the pixels included in the first group and the pixels included in the second group are arranged adjacent to each another in vertical and horizontal directions on an imaging surface of the image sensor.

This imaging apparatus prevents the pixels included in the first group from being arranged adjacent to one another in the vertical and horizontal directions on the imaging surface of the image sensor, and also prevents the pixels included in the second group from being arranged adjacent to one another in the vertical and horizontal directions on the imaging surface. In other words, the pixels arranged on the imaging surface of the image sensor are driven with two different charge accumulation times in a manner that alternate pixels in the vertical and horizontal directions on the imaging surface are driven with one charge accumulation time and the remaining alternate pixels are driven with the other charge accumulation time. The imaging apparatus thereby effectively reduces noise of a processed image that can be generated due to different charge accumulation times.

A fourth aspect of the present invention provides the imaging apparatus in which the imaging unit includes the image sensor in which the pixels included in the first group and the pixels included in the second group are arranged adjacent to each another in a vertical direction on an imaging surface of the image sensor.

This imaging apparatus effectively reduces noise of a processed image that can be generated due to different charge accumulation times.

A fifth aspect of the present invention provides the imaging apparatus of the first or second aspect of the present invention in which the imaging unit includes the image sensor in which the pixels included in the first group and the pixels included in the second group are arranged adjacent to each another in a horizontal direction on an imaging surface of the image sensor.

This imaging apparatus effectively reduces noise of a processed image that can be generated due to different charge accumulation times.

A sixth aspect of the present invention provides the imaging apparatus of one of the first to fifth aspects of the present invention in which the charge accumulation time setting unit sets the first charge accumulation time at n/100 second, where n is a natural number, when the power supply frequency of illumination is 50 Hz, and sets the first charge accumulation time at n/120 second, where n is a natural number, when the power supply frequency of illumination is 60 Hz.

This imaging apparatus easily generates a first image signal including no flicker element.

It is preferable that n is an integer that sets the first charge accumulation time at a maximum value that is not greater than the time corresponding to one frame.

A seventh aspect of the present invention provides an imaging method used in an imaging apparatus including an imaging unit whose image sensor has a first group of pixels and a second group of pixels that are driven independently of each other. The method includes a charge accumulation time setting process, a switch process, a drive process, a signal switching process, a first gain correction process, a gain calculation process, a second gain correction process, and a signal combining process. In the charge accumulation time setting process, a first charge accumulation time with which no flicker element is generated due to a power supply frequency of illumination and a second charge accumulation time different from the first charge accumulation time are set for an image that is formed by the imaging unit. In the switch process, a charge accumulation time for the first group of pixels and a charge accumulation time for the second group of pixels are switched for every frame between the first charge accumulation time and the second charge accumulation time. In the drive process, the pixels included in the first group and the pixels included in the second group are driven with the first charge accumulation time and the second charge accumulation time that are switched for every frame in the switch process. In the signal switching process, an image signal obtained with the first charge accumulation time by the imaging unit is output as a first image signal, and an image signal obtained with the second charge accumulation time by the imaging unit is output as a second image signal. In the first gain correction process, gain correction is performed to adjust a signal level of the first image signal to a signal level of the second image signal. In the gain calculation process, a gain correction coefficient for correcting a flicker element included in the second image signal is calculated based on the first image signal and the second image signal. In the second gain correction process, a flicker element included in the second image signal is corrected based on the gain correction coefficient. In the signal combining process, the second image signal corrected in the second gain correction process and the first image signal subjected to gain correction performed in the first gain correction process are combined in an arrangement identical to an arrangement of the first group of pixels and the second group of pixels in the image sensor.

When this method is used in the imaging apparatus that includes the imaging unit whose image sensor includes the first group of pixels and the second group of pixels that are driven independently of each other, the imaging method has the same advantageous effects as the imaging apparatus of the first aspect of the present invention.

An eighth aspect of the present invention provides a storage medium storing a computer-readable program that is used in an imaging apparatus including an imaging unit whose image sensor has a first group of pixels and a second group of pixels that are driven independently of each other. The program enables a computer to function as a charge accumulation time setting unit, a switch unit, a drive unit, a signal switching unit, a first gain correction unit, a gain calculation unit, a second gain correction unit, and a signal combining unit. The charge accumulation time setting unit sets, for an image that is formed by the imaging unit, a first charge accumulation time with which no flicker element is generated due to a power supply frequency of illumination and a second charge accumulation time different from the first charge accumulation time. The switch unit switches, for every frame, a charge accumulation time for the first group of pixels and a charge accumulation time for the second group of pixels between the first charge accumulation time and the second charge accumulation time. The drive unit drives the pixels included in the first group and the pixels included in the second group with the first charge accumulation time and the second charge accumulation time that are switched for every frame by the switch unit. The signal switching unit outputs an image signal obtained with the first charge accumulation time by the imaging unit as a first image signal, and outputs an image signal obtained with the second charge accumulation time by the imaging unit as a second image signal. The first gain correction unit performs gain correction to adjust a signal level of the first image signal to a signal level of the second image signal. The gain calculation unit calculates a gain correction coefficient for correcting a flicker element included in the second image signal based on the first image signal and the second image signal. The second gain correction unit corrects a flicker element included in the second image signal based on the gain correction coefficient. The signal combining unit combines the second image signal corrected by the second gain correction unit and the first image signal subjected to gain correction performed by the first gain correction unit in an arrangement identical to an arrangement of the first group of pixels and the second group of pixels in the image sensor.

When this program is used in the imaging apparatus that includes the imaging unit whose image sensor includes the first group of pixels and the second group of pixels that are driven independently of each other, the program has the same advantageous effects as the imaging apparatus of the first aspect of the present invention.

A ninth aspect of the present invention provides an integrated circuit including an imaging unit, a charge accumulation time setting unit, a switch unit, a drive unit, a signal switching unit, a first gain correction unit, a gain calculation unit, a second gain correction unit, and a signal combining unit. The imaging unit includes an image sensor having a first group of pixels and a second group of pixels that are driven independently of each other. The charge accumulation time setting unit sets, for an image that is formed by the imaging unit, a first charge accumulation time with which no flicker element is generated due to a power supply frequency of illumination and a second charge accumulation time different from the first charge accumulation time. The switch unit switches, for every frame, a charge accumulation time for the first group of pixels and a charge accumulation time for the second group of pixels between the first charge accumulation time and the second charge accumulation time. The drive unit drives the pixels included in the first group and the pixels included in the second group with the first charge accumulation time and the second charge accumulation time that are switched for every frame by the switch unit. The signal switching unit outputs an image signal obtained with the first charge accumulation time by the imaging unit as a first image signal, and outputs an image signal obtained with the second charge accumulation time by the imaging unit as a second image signal. The first gain correction unit performs gain correction to adjust a signal level of the first image signal to a signal level of the second image signal. The gain calculation unit calculates a gain correction coefficient for correcting a flicker element included in the second image signal based on the first image signal and the second image signal. The second gain correction unit corrects a flicker element included in the second image signal based on the gain correction coefficient. The signal combining unit combines the second image signal corrected by the second gain correction unit and the first image signal subjected to gain correction performed by the first gain correction unit in an arrangement identical to an arrangement of the first group of pixels and the second group of pixels in the image sensor.

The integrated circuit has the same advantageous effects as the imaging apparatus of the first aspect of the present invention.

A tenth aspect of the present invention provides an integrated circuit that is used in an imaging apparatus including an imaging unit whose image sensor has a first group of pixels and a second group of pixels that are driven independently of each other. The integrated circuit includes a charge accumulation time setting unit, a switch unit, a drive unit, a signal switching unit, a first gain correction unit, a gain calculation unit, a second gain correction unit, and a signal combining unit. The charge accumulation time setting unit sets, for an image that is formed by the imaging unit, a first charge accumulation time with which no flicker element is generated due to a power supply frequency of illumination and a second charge accumulation time different from the first charge accumulation time. The switch unit switches, for every frame, a charge accumulation time for the first group of pixels and a charge accumulation time for the second group of pixels between the first charge accumulation time and the second charge accumulation time. The drive unit drives the pixels included in the first group and the pixels included in the second group with the first charge accumulation time and the second charge accumulation time that are switched for every frame by the switch unit. The signal switching unit outputs an image signal obtained with the first charge accumulation time by the imaging unit as a first image signal, and outputs an image signal obtained with the second charge accumulation time by the imaging unit as a second image signal. The first gain correction unit performs gain correction to adjust a signal level of the first image signal to a signal level of the second image signal. The gain calculation unit calculates a gain correction coefficient for correcting a flicker element included in the second image signal based on the first image signal and the second image signal. The second gain correction unit corrects a flicker element included in the second image signal based on the gain correction coefficient. The signal combining unit combines the second image signal corrected by the second gain correction unit and the first image signal subjected to gain correction performed by the first gain correction unit in an arrangement identical to an arrangement of the first group of pixels and the second group of pixels in the image sensor.

When this integrated circuit is used in the imaging apparatus that includes the imaging unit whose image sensor includes the first group of pixels and the second group of pixels that are driven independently of each other, the integrated circuit has the same advantageous effects as the imaging apparatus of the first aspect of the present invention.

### Advantageous Effects

The present invention provides an imaging apparatus, an imaging method, a storage medium storing a program, and an integrated circuit for appropriately correcting flicker in real time even when an imaging apparatus (camera) is moved and also effectively reducing noise of a captured image generated by low-sensitive pixel areas that are fixed on an imaging surface.

### BRIEF DESCRIPTION OF THE DRAWINGS

FIG. 1 shows the structure of an imaging apparatus 100 according to a first embodiment of the present invention.

FIG. 2 schematically shows the structure of an imaging unit 1 and a drive unit 7 included in the imaging apparatus 100 according to the first embodiment (for an odd frame).

FIG. 3 schematically shows the structure of the imaging unit 1 and the drive unit 7 included in the imaging apparatus 100 according to the first embodiment (for an even frame).

FIGS. 4A and 4B are diagrams describing the operation of the imaging apparatus 100 of the first embodiment for switching the arrangement of pixels driven with two charge accumulation times depending on each frame.

FIGS. 5A, 5B, and 5C are diagrams describing the arrangement of pixels A and pixels B of the imaging unit 1 included in the imaging apparatus 100 according to the first embodiment.

FIG. 6 shows the structure of a conventional imaging apparatus.

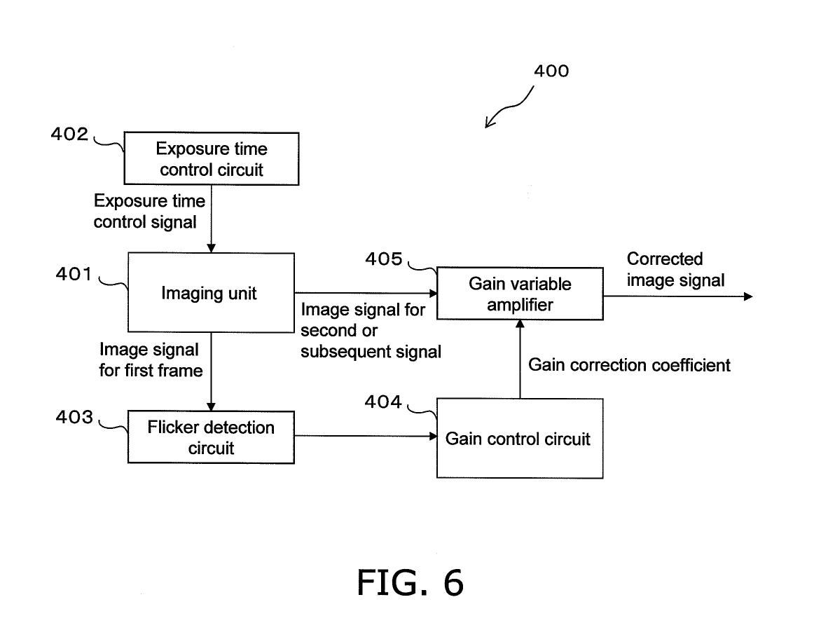

FIG. 7 is a diagram describing flicker generated in a typical imaging apparatus with a frame rate of 60 fps under illumination with a power supply frequency of 50 Hz.

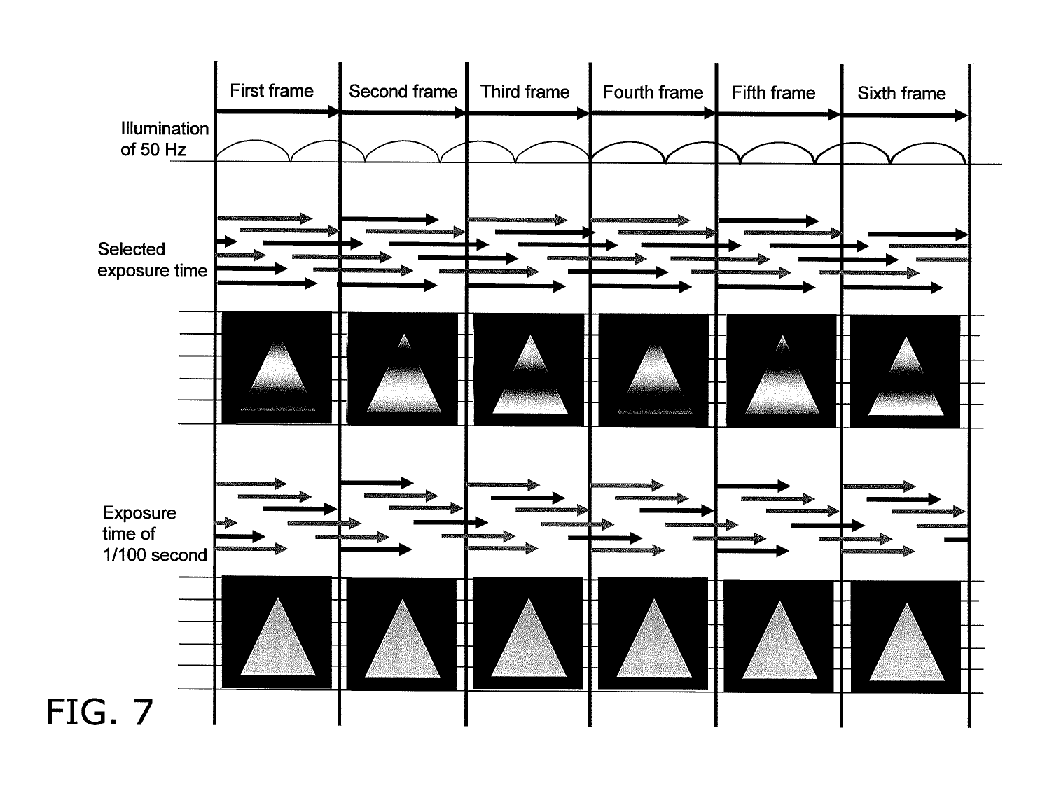

FIG. 8 is a diagram describing a process for correcting images captured with two different charge accumulation times.

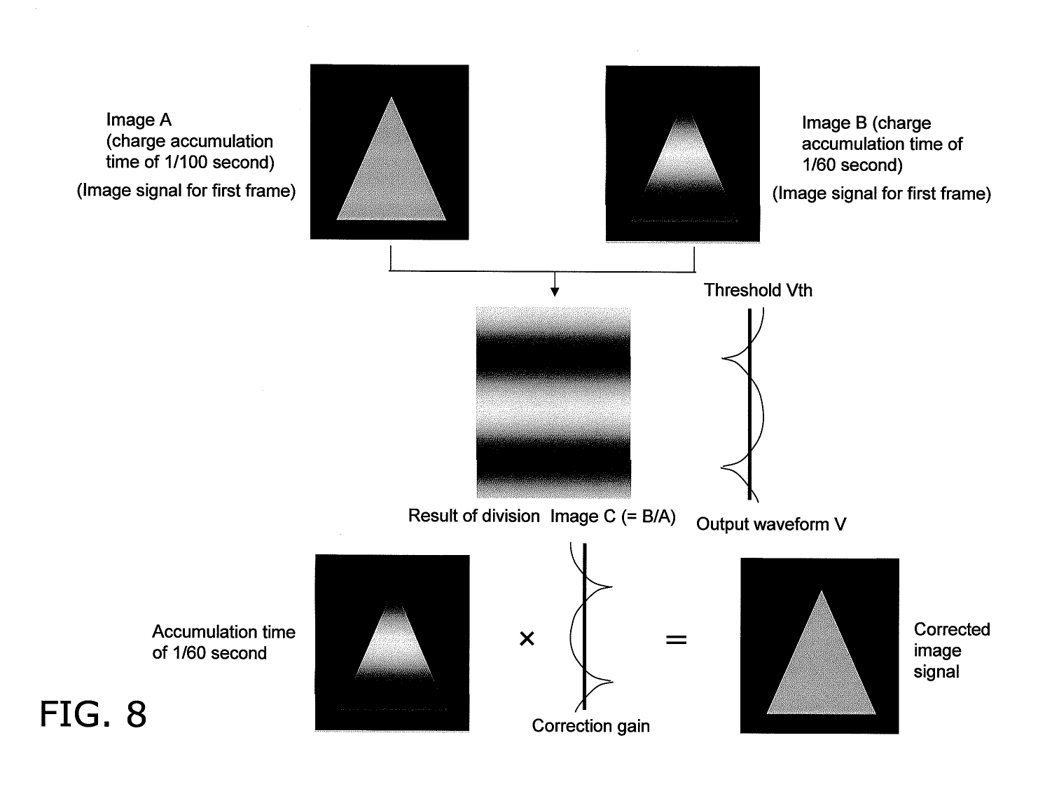

### BEST MODE FOR CARRYING OUT THE INVENTION

An embodiment of the present invention will now be described with reference to the drawings.

### First Embodiment

### 1. Structure of the Imaging Apparatus

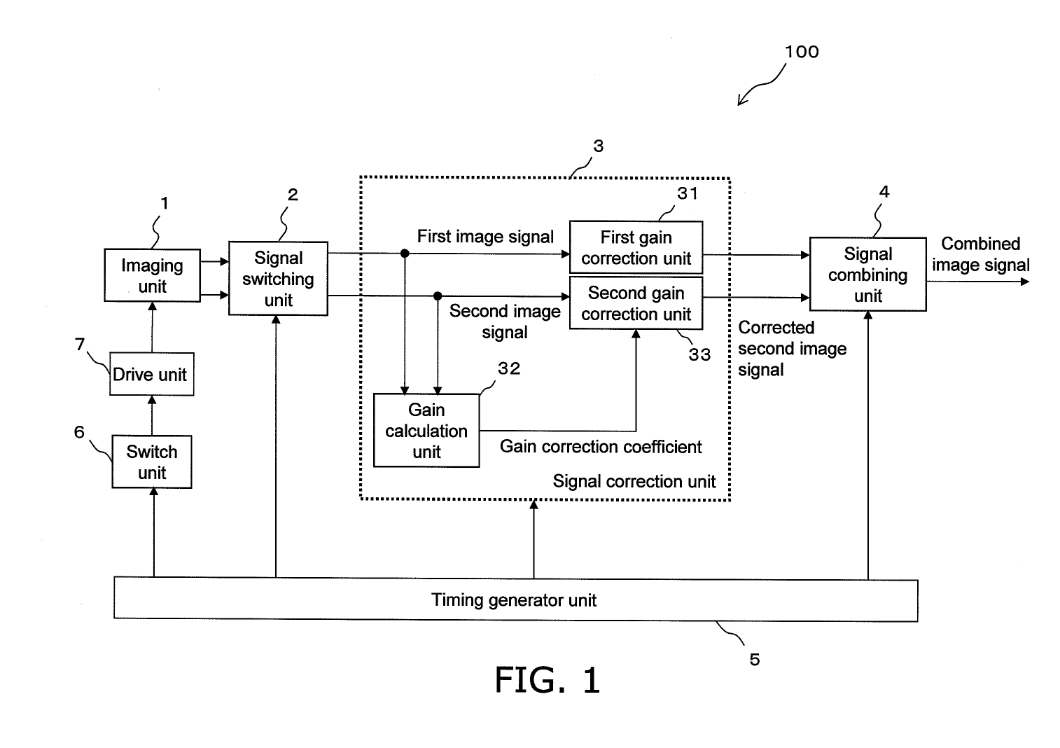

FIG. 1 shows the structure of an imaging apparatus 100 according to a first embodiment of the present invention.

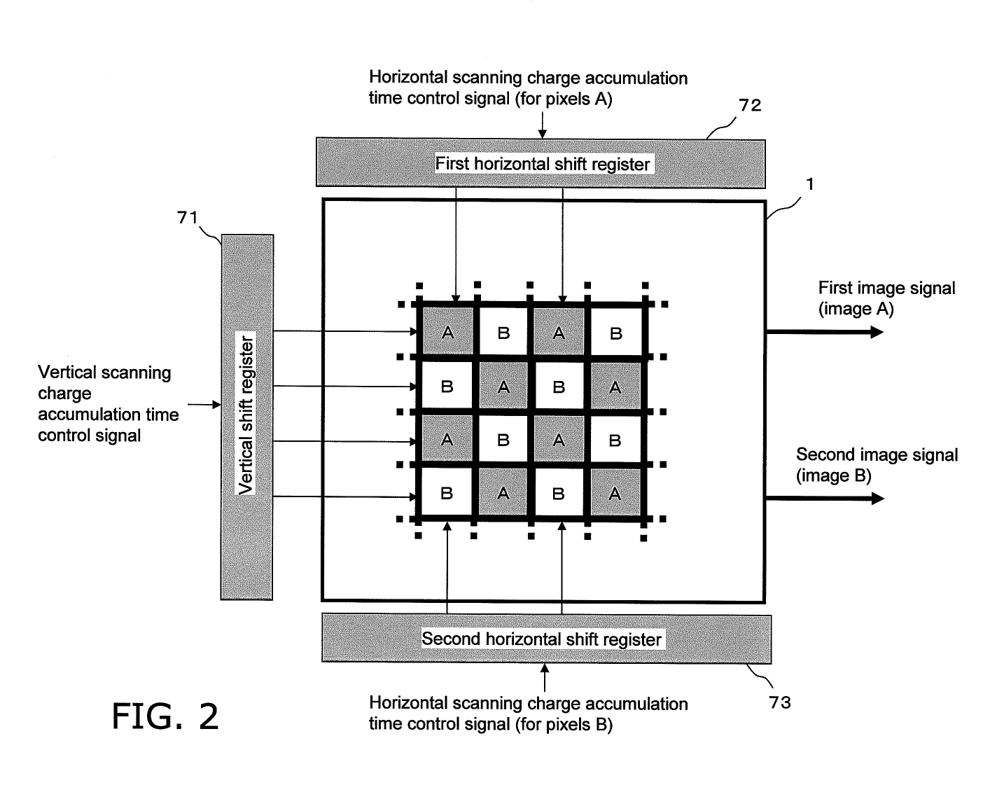

FIG. 2 shows the schematic structure of an imaging unit 1 and a drive unit 7.

The imaging apparatus 100 includes the imaging unit 1, a switch unit 6, the drive unit 7, and a signal switching unit 2. The imaging unit 1 converts light from a subject by photoelectric conversion to generate a first image signal (image signal including no flicker element) and a second image signal. The switch unit 6 switches a charge accumulation time control signal for controlling the charge accumulation time of pixels included in the imaging unit 1 depending on each frame. The drive unit 7 drives the pixels of the imaging unit 1 based on the charge accumulation time control signal. The signal switching unit 2 switches the output destination of the first image signal and the second image signal obtained by the imaging unit 1 to a first gain correction unit or to a second gain correction unit depending on each frame. The imaging apparatus 100 further includes a signal correction unit 3 and a signal combining unit 4. The signal correction unit 3 corrects the flicker element included in the second image signal based on the first image signal and the second image signal output from the signal switching unit 2, and also adjusts the signal level of the first image signal to eliminate a difference between the signal level of the first image signal and the signal level of the second image signal, which differ from each other due to different charge accumulation times. The signal combining unit 4 combines the first image signal (first image signal subjected to gain adjustment) and the second image signal (corrected second image signal), which are output from the signal correction unit 3, and outputs the resulting combined image signal. The imaging apparatus 100 further includes a timing generator unit 5, which outputs a control signal to each unit and a charge accumulation time control signal to the switch unit 6. The control signal is used to adjust the operation timing of each unit. The charge accumulation time control signal is used to drive the pixels of the imaging unit 1 with predetermined charge accumulation times.

Although not shown, the imaging apparatus 100 further includes an overall control unit that controls each unit of the imaging apparatus 100 (including the operation timing of each unit).

The imaging unit 1 converts light from a subject by photoelectric conversion to generate a first image signal (image signal including no flicker element) and a second image signal. The imaging unit 1 is an image sensor including a plurality of pixels, which can be driven independently of one another. The imaging unit 1 can be driven with charge accumulation times (exposure times) set differently for different pixels. As shown in FIG. 2, the imaging unit 1 outputs, as a first image signal, an image signal obtained from pixels A that are driven with a first charge accumulation time, with which no flicker element is generated (an image formed by pixels A is referred to as an “image A”), to the signal switching unit 2. The imaging unit 1 outputs, as a second image signal, an image signal obtained from pixels B that are driven with a second charge accumulation time, with which a flicker element is generated (an image formed by pixels B is referred to as “image B”), to the signal switching unit 2.

When, for example, the illumination power supply frequency is 50 Hz, the first charge accumulation time is set at n/100 second (where n is an integer that sets the charge accumulation time at a maximum value not greater than the time corresponding to one frame), and the second charge accumulation time is set at any selected time. When the illumination power supply is 60 Hz, the first charge accumulation time is set at n/120 second (where n is an integer that sets the exposure time at a maximum value not greater than the one-frame time) and the second charge accumulation time is set at any selected time.

It is preferable to use a complementary metal oxide semiconductor (CMOS) image sensor as the imaging unit 1.

The switch unit 6 receives a charge accumulation time control signal output from the timing generator unit 5, and outputs the charge accumulation time control signal to the drive unit 7. The switch unit 6 switches the charge accumulation time control signal depending on each frame. The charge accumulation time control signal, which is switched by the switch unit 6, switches pixel areas driven in the imaging unit 1 depending on each frame.

For example, the charge accumulation time control signal for one frame is assumed to be output to the drive unit 7 in a manner that the charge accumulation time for pixels arranged in even vertical lines on the imaging surface of the imaging unit is set as the first charge accumulation time and the charge accumulation time for pixels arranged in odd vertical lines on the imaging surface is set as the second charge accumulation time. In this case, the charge accumulation time control signal for the next frame is output to the drive unit 7 in a manner that the charge accumulation time for pixels arranged in even vertical lines is set as the second charge accumulation time and the charge accumulation time for pixels arranged in odd vertical lines is set as the first charge accumulation time.

The drive unit 7 drives the pixels of the imaging unit 1 based on the charge accumulation time control signal. As shown in FIG. 2, the drive unit 7 includes a vertical shift register 71, a first horizontal shift register 72, and a second horizontal shift register 73.

The charge accumulation time control signal provided from the switch unit 6 is input into the vertical shift register 71, the first horizontal shift register 72, and the second horizontal shift register 73. Based on the charge accumulation time control signal, the vertical shift register 71, the first horizontal shift register 72, and the second horizontal shift register 73 each generate a drive signal for driving the pixels of the imaging unit 1 in a manner that the pixels are driven with their predetermined charge accumulation times (exposure times). FIG. 2 shows the case in which the charge accumulation time control signal includes a vertical scanning charge accumulation time control signal, a horizontal scanning charge accumulation time control signal (for pixels A), and a horizontal scanning charge accumulation time control signal (for pixels B). As shown in FIG. 2, the vertical scanning charge accumulation time control signal is input into the vertical shift register 71, the horizontal scanning charge accumulation time control signal (for pixels A) is input into the first horizontal shift register 27, and the horizontal scanning charge accumulation time control signal (for pixels B) is input into the second horizontal shift register 73. The vertical shift register 71 generates a drive signal for driving the pixels of the imaging unit 1 based on the vertical scanning charge accumulation time control signal. The first horizontal shift register 72 generates a drive signal for driving the pixels A of the imaging unit 1 based on the horizontal scanning charge accumulation time control signal (for pixels A). The second horizontal shift register 73 generates a drive signal for driving the pixels B of the imaging unit 1 based on the horizontal scanning charge accumulation time control signal (for pixels B). The pixels A of the imaging unit 1 are driven based on a drive signal generated by the vertical shift register 71 and a drive signal generated by the first horizontal shift register 72. The pixels B of the imaging unit 1 are driven based on a drive signal generated by the vertical shift register 71 and a drive signal generated by the second horizontal shift register 73. The charge accumulation time (exposure time) for the pixels A and the charge accumulation time (exposure time) for the pixels B are controlled using the vertical scanning charge accumulation time control signal, the horizontal scanning charge accumulation time control signal (for pixels A), and the horizontal scanning charge accumulation time control signal (for pixels B).

The signal switching unit 2 receives a signal-switching control signal output from the timing generator unit 5 and a first image signal and a second image signal output from the imaging unit 1. Based on the signal-switching control signal output from the timing generator unit 5, the signal switching unit 2 switches the output destination of the first image signal and the second image signal obtained by the imaging unit 1 to the first gain correction unit or to the second gain correction unit depending on each frame.

The signal correction unit 3 corrects the flicker element included in the second image signal based on the first image signal and the second image signal output from the signal switching unit 2, and also adjusts the signal level of the first image signal to eliminate a difference between the signal level of the first image signal and the signal level of the second image signal, which differ from each other due to different charge accumulation times.

The signal correction unit 3 includes a first gain correction unit 31, a gain calculation unit 32, and a second gain correction unit 33.

The first gain correction unit 31 receives the first image signal output from the signal switching unit 2 and information about the first charge accumulation time and the second charge accumulation time output from the timing generator unit 5. The first gain correction unit 31 then adjusts the signal level of the first image signal to eliminate a difference between the signal level of the first image signal and the signal level of the second image signal, which differ from each other due to different charge accumulation times, and outputs the resulting first image signal to the signal combining unit 4. For example, the first gain correction unit 31 calculates the gain G as G1=T2/T1, where T1 is the first charge accumulation time (for example, T1= 1/100 second when the power supply frequency is 50 Hz) and T2 is the second charge accumulation time (for example, T2= 1/60 second when the power supply frequency is 50 Hz), and adjusts the signal level of the first image signal to the signal level of the second image signal by multiplying the first image signal by the gain G1.

When T2>T1, it is preferable to adjust the signal level of the first image signal by multiplying the first image signal by the gain G1. When T2<T1, it is preferable that the second gain correction unit adjusts the signal level of the image signal.

The gain calculation unit 32 receives the first image signal and the second image signal output from the signal switching unit 2. Based on the first image signal and the second image signal, the gain calculation unit 32 calculates a gain correction coefficient for correcting the flicker element of the second image signal for each line, and outputs the calculated gain correction coefficient to the second gain correction unit 33.

The signal combining unit 4 receives the first image signal output from the signal correction unit 3 (first image signal subjected to gain adjustment) and the second image signal (corrected second image signal), and combines the first image signal (first image signal subjected to gain adjustment) and the second image signal (corrected second image signal), and outputs the resulting combined image signal. More specifically, the signal combining unit 4 generates the combined image signal by combining the first image signal (first image signal subjected to gain adjustment) and the second image signal (corrected second image signal) in the same arrangement as the arrangement of the pixels of the imaging unit based on, for example, information about the positions of pixels A and B output from the timing generator unit 5 and information about frame switching, and outputs the combined image signal.

The timing generator unit 5 outputs a control signal, which is used to adjust the timing of each unit, to each unit. The timing generator unit 5 also outputs a charge accumulation time control signal, which is used to drive the pixels of the imaging unit 1 with their predetermined charge accumulation times, to the switch unit 6. The timing generator unit 5 outputs the signal-switching control signal and other information, such as the information about the positions of the pixels A and B and the information about frame switching, to the signal switching unit 2, the signal correction unit 3, and the signal combining unit 4. The timing generator unit 5 functions as the charge accumulation time setting unit.

### 2. Operation of the Imaging Apparatus

The operation of the imaging apparatus 100 with the above-described structure will now be described. For ease of explanation, the power supply frequency of the illumination is assumed to be 50 Hz, the first charge accumulation time is assumed to be 1/100 second, and the second charge accumulation time is assumed to be 1/60 second.

### 2.1 Operation for Odd Frame

The operation of the imaging apparatus 100 for an odd frame will first be described. Light from a subject is converted by photoelectric conversion, which is performed by the imaging unit 1, to generate a first image signal and a second image signal. The charge accumulation time for pixels A of the imaging unit 1 (first charge accumulation time) is set at n/100 second and the charge accumulation time for pixels B of the imaging unit 1 (second charge accumulation time) is set at any selected time (any selected time other than n/100 second) based on a charge accumulation time control signal provided from the timing generator unit 5. In this example, n=1. In other words, the first charge accumulation time is set at 1/100 second, whereas the second charge accumulation time is set at 1/60 second. For an odd frame, pixels both in odd horizontal lines and odd vertical lines and pixels both in even horizontal lines and even vertical lines on the imaging surface of the imaging unit 1 are set as pixels A, whereas pixels both in odd horizontal lines and even vertical lines and pixels both in even horizontal lines and odd vertical lines are set as pixels B as shown in FIG. 2.

As shown in FIG. 2, the first image signal is obtained by accumulating charge in the pixels A of the imaging unit 1 for the first charge accumulation time ( 1/100 second) set based on the charge accumulation time control signal, which is output from the switch unit 6. The second image signal is obtained by accumulating charge in the pixels B of the imaging unit 1 for the charge accumulation time ( 1/60 second) set based on the charge accumulation time control signal, which is output from the switch unit 6.

The power supply frequency of the illumination is 50 Hz. In this case, the first image signal obtained with the first charge accumulation time of 1/100 second includes no flicker element, whereas the second image signal includes a flicker element.

The first image signal and the second image signal are input into the signal switching unit 2. For an odd frame, the signal switching unit 2 outputs, as the first image signal, a signal obtained from the pixels both in the odd horizontal lines and the odd vertical lines and the pixels both in the even horizontal lines and the even vertical lines to the first gain correction unit 31 and the gain calculation unit 32. The signal switching unit 2 outputs, as the second image signal, a signal obtained from the pixels both in the odd horizontal lines and the even vertical lines and the pixels both in the even horizontal lines and the odd vertical lines to the second gain correction unit 33 and the gain calculation unit 32.

Based on the first image signal, the gain calculation unit 32 calculates an average value A′ for each line (horizontal line) of the image A, which is formed using the first image signal. The gain calculation unit 32 further calculates an average value B′ for each line (horizontal line) of the image B, which is formed using the second image signal. The gain calculation unit 32 calculates the ratio of the average values of the lines, which is written as C′=A′/B′. The calculated line average ratio, which is written as C′=A′/B′, is output from the gain calculation unit 32 to the second gain correction unit 33 as the gain correction coefficient.

The first image signal is input into the first gain correction unit 31. The first gain correction unit 31 adjusts the signal level of the first image signal, and outputs the adjusted first image signal to the signal combining unit 4. More specifically, the first gain correction unit 31 calculates the gain G1 as G1=T2/T1, where T1 is the first charge accumulation time (T1= 1/100 second) and T2 is the second charge accumulation time (T2= 1/60 second). The first gain correction unit 31 then multiplies the first image signal by the calculated gain G1 to adjust the signal level of the first image signal to the signal level of the second image signal. The first image signal, whose signal level has been adjusted in this manner, is then output to the signal combining unit 4.

The second gain correction unit 33 multiplies the second image signal corresponding to each line by the gain correction coefficient (C′=A′/B′) to eliminate the flicker element from the second image signal. The second gain correction unit 33 outputs the corrected second image signal, which is the signal from which the flicker element has been eliminated, to the signal combining unit 4.

The first image signal and the corrected second image signal output from the first gain correction unit 31 are input into the signal combining unit 4. The signal combining unit 4 converts the signals to a combined image signal by combining the signals in the same arrangement as the arrangement of the imaging surface of the imaging unit 1 (in the same arrangement as the arrangement of the pixels of the imaging unit 1).

The signal combining unit 4 then outputs the combined image signal as the image signal from which the flicker element has been corrected (eliminated).

### 2.2 Operation for Even Frame

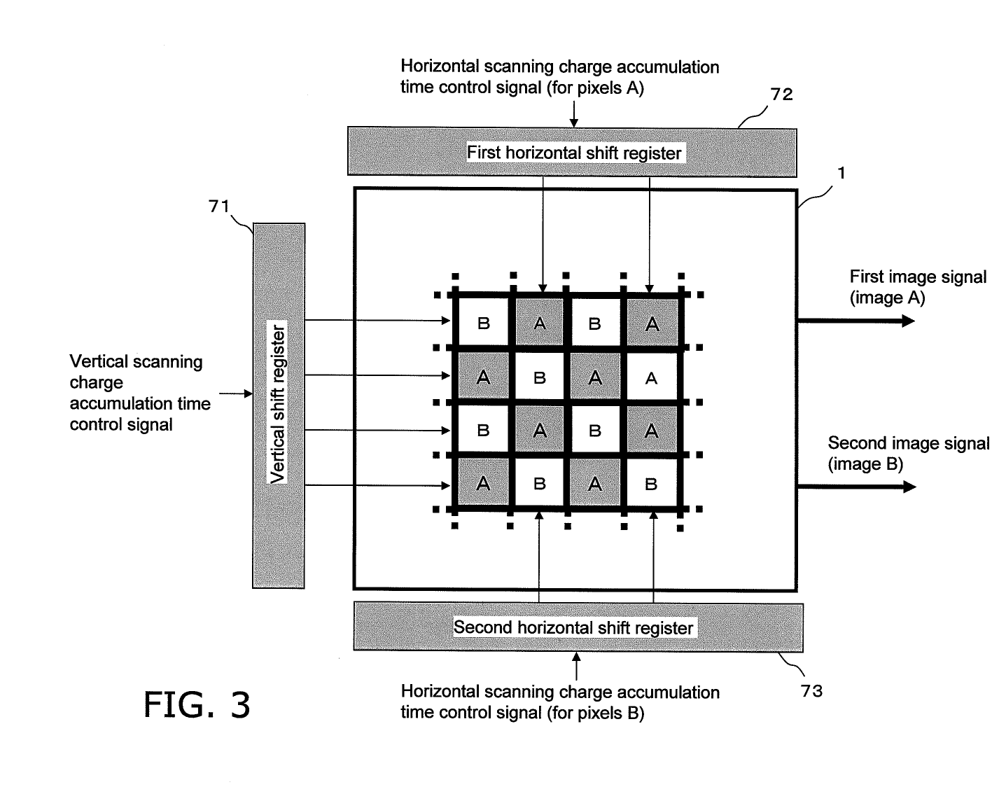

FIG. 3 shows the schematic structure of the imaging unit 1 and the drive unit 7 to describe the operation of the imaging apparatus 100 for an even frame.

The operation of the imaging apparatus 100 for an even frame will now be described. The charge accumulation time for the pixel area that has been driven with the first charge accumulation time ( 1/100 second) for the odd frame (area consisting of the pixels both in the odd horizontal lines and the odd vertical lines and the pixels both in the even horizontal lines and the even vertical lines) is set as the second charge accumulation time ( 1/60 second). The charge accumulation time for the pixel area that has been driven with the second charge accumulation time for the odd frame (area consisting of the pixels both in the odd horizontal lines and the even vertical lines and the pixels both in the even horizontal lines and the odd vertical lines) is set as the first charge accumulation time ( 1/100 second). More specifically, the pixels both in the odd horizontal lines and the odd vertical lines and the pixels both in the even horizontal lines and the even vertical lines on the imaging surface of the imaging unit 1 are set as pixels B, whereas the pixels both in the odd horizontal lines and the even vertical lines and the pixels both in the even horizontal lines and the odd vertical lines on the imaging surface are set as pixels A as shown in FIG. 3.

The pixels A and the pixels B are set based on the charge accumulation time control signal, which is set by the timing generator unit 5 and switched by the switch unit 6 depending on each frame.

A first image signal obtained from the pixels A and a second image signal obtained from the pixels B are input into the signal switching unit 2.

The signal switching unit 2 outputs, as the first image signal, the signal obtained from the pixels both in the odd horizontal lines and the even vertical lines on the imaging surface of the imaging unit 1 and the signal obtained from the pixels both in the even horizontal lines and the odd horizontal lines on the imaging surface to the first gain correction unit 31 and the gain calculation unit 32. The signal switching unit 2 outputs, as the second image signal, the signal obtained from the pixels both in the odd horizontal lines and the odd vertical lines on the imaging surface of the imaging unit 1 and the signal obtained from the pixels both in the even horizontal lines and the even vertical lines on the imaging surface to the second gain correction unit 33 and the gain calculation unit 32.

The same operation (processing) as the operation performed for an odd frame is performed hereafter.

When completing the processing for an odd frame, the imaging apparatus 100 performs the processing for an even frame again.

As described above, the imaging apparatus 100 alternately switches the charge accumulation times of the pixel areas on the imaging surface of the imaging unit 1, which are driven independently of each other, depending on each frame. The imaging apparatus 100 therefore appropriately corrects flicker even when the imaging apparatus (camera) is moved, and also effectively reduces noise of a captured image generated by low-sensitive pixel areas that are fixed on the imaging surface.

The positions of the pixels A and the pixels B for each frame should not be limited to the positions described above.

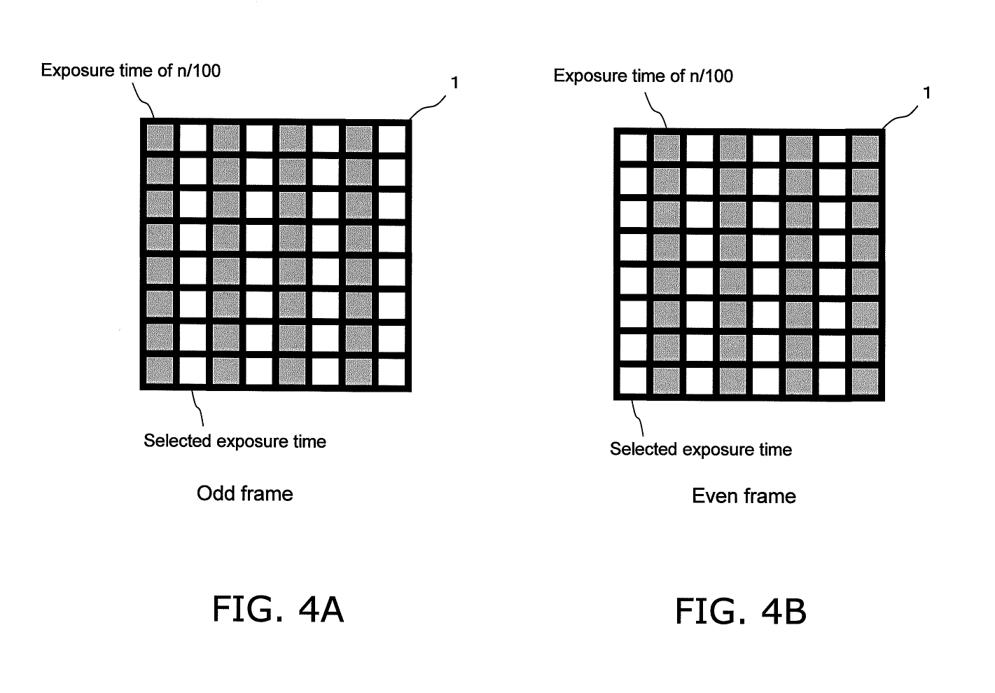

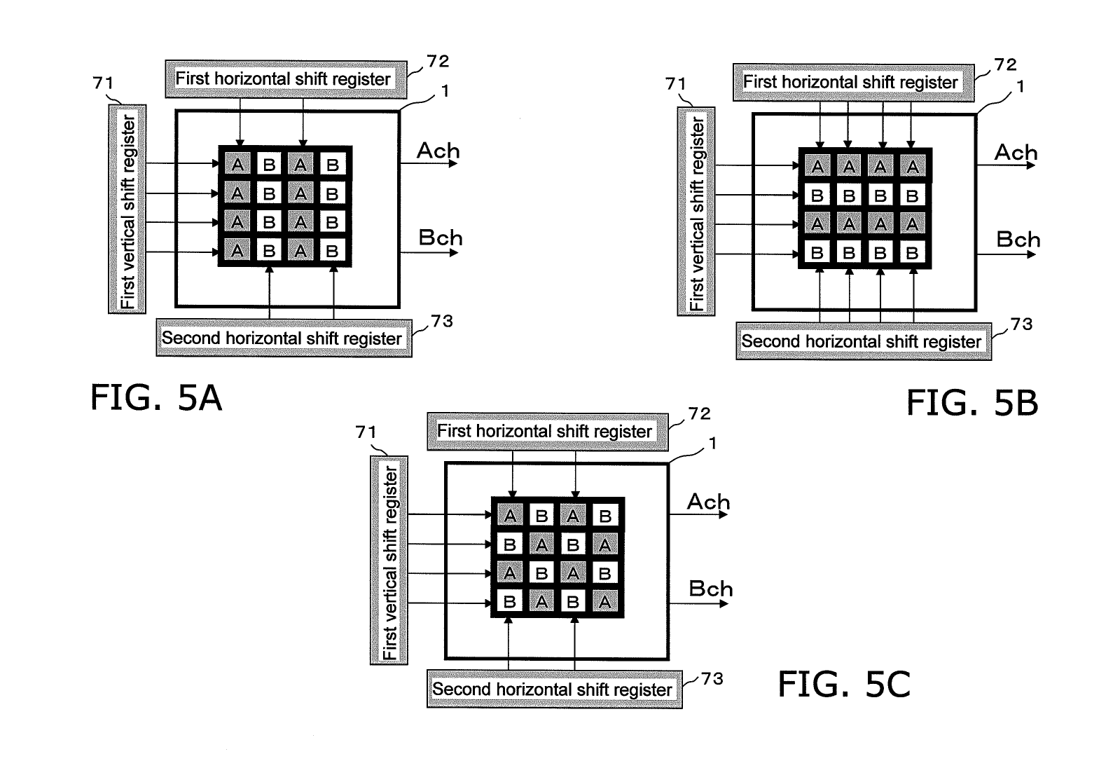

FIGS. 4A and 4B and FIGS. 5A, 5B, and 5C show other examples.

FIGS. 4A and 4B show an imaging unit 1 including pixel areas that are driven with different charge accumulation times. In this example, each pixel area consists of alternate vertical lines of pixels.

For an odd frame, the charge accumulation time for pixels in the odd vertical lines is set at n/100 second, whereas the charge accumulation time for pixels in the even vertical lines is set at any selected time as shown in FIG. 4A.

For an even frame, the charge accumulation time for pixels in the odd vertical lines is set at any selected time, whereas the charge accumulation time for pixels in the even vertical lines is set at n/100 second as shown in FIG. 4B.

The imaging apparatus 100 may set the positions of the pixels A and the pixels B depending on each frame in the manner as described above.

The imaging apparatus 100 calculates the gain correction coefficient for correcting the flicker element through division processing using the two image signals obtained from two pixel areas with different charge accumulation times. In this case, flicker correction may have large errors if pixels of the imaging unit 1 with different charge accumulation times in FIG. 1 are not adjacent to each other. In view of movement, it is more preferable to set pixels with different charge accumulation times in the horizontal scanning direction, in which the pixels are driven with little difference in the exposure timing (little difference in the charge accumulation time). Therefore, it is preferable to use different horizontal shift registers to scan different vertical lines of pixels and also to set the positions of pixels A and pixels B in the manner shown in FIG. 5A.

However, when the subject includes a fine strip pattern in the horizontal scanning direction, it is preferable to use different horizontal shift registers to scan different pixel lines as shown in FIG. 5B and also to set the positions of pixels A and pixels B in the manner shown in FIG. 5B.

Alternatively, the positions of pixels A and pixels B may be set in a manner that alternate pixels in each line are driven with one charge accumulation time and the remaining alternate pixels in each line is driven with another charge accumulation time as shown in FIG. 5C. In this case, even when the subject includes any of a horizontal stripe pattern and a vertical stripe pattern, the imaging apparatus effectively reduces noise of a captured image generated by low-sensitive pixel areas that are fixed on the imaging surface.

As described above, the imaging apparatus 100 obtains a first image signal including no flicker element and a second image signal including a flicker element depending on each frame, calculates a gain correction coefficient used to eliminate the flicker element included in the second image signal based on the first image signal and the second image signal, eliminates the flicker element from the second image signal based on the gain correction coefficient, and combines the first image signal and the second image signal to generate an image signal from which the flicker element has been eliminated.

A conventional imaging apparatus detects a flicker element of an image corresponding to only a single frame out of a plurality of frames, and calculates a gain correction value for a frame subsequent to the frame for which the flicker element has been detected. The conventional imaging apparatus then calculates the gain correction value based on phase information associated with the flicker element detected for the previous frame. More specifically, the imaging apparatus detects a flicker element using one frame and corrects a flicker element of another frame.

In contrast, the imaging apparatus 100 of the present invention calculates a gain correction coefficient used in flicker correction based on information about a frame image to be corrected. More specifically, the imaging apparatus 100 detects a flicker element for one frame and corrects the flicker element of the same frame.

Also, the imaging apparatus 100 changes the positions of pixels A and pixels B depending on each frame. The imaging apparatus 100 with this structure prevents low-sensitive pixel areas from being fixed on the imaging surface and therefore effectively reduces noise of a captured image generated by low-sensitive image areas that are fixed on the imaging surface.

The imaging apparatus 100 of the present invention appropriately corrects flicker even when the imaging apparatus 100 is moved, and also effectively reduces noise of a captured image generated by low-sensitive pixel areas that are fixed on the imaging surface.

### Other Embodiments

In the above embodiments, each block of the imaging apparatus may be formed by a single chip with semiconductor device technology, such as LSI (large-scale integration), or some or all of the blocks of the imaging apparatus may be formed by a single chip.

Although the semiconductor device technology is referred to as LSI, the technology may be instead referred to as IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the imaging apparatus. Biotechnology is potentially applicable.

The processes described in the above embodiments may be realized using either hardware or software, or may be realized using both software and hardware. When the imaging apparatus of the above embodiments is realized by hardware, the timings at which each of the above processes is performed need to be adjusted. For ease of explanation, the timing adjustment of various signals generated in an actual hardware design is not described in the above embodiments.

The structures described in detail in the above embodiments are mere examples of the present invention, and may be changed and modified variously without departing from the scope and spirit of the invention.

### INDUSTRIAL APPLICABILITY

The imaging apparatus, the imaging method, the storage medium storing the program, and the integrated circuit of the present invention enable effective correction (elimination) of a flicker element that is generated due to a power supply frequency of illumination. The imaging apparatus, the imaging method, the storage medium storing the program, and the integrated circuit of the present invention are therefore useful in the video equipment related industry and have applicability in such industry.

What is claimed is:

1. An imaging apparatus, comprising:
an imaging unit including an image sensor having a first group of pixels and a second group of pixels that are driven independently of each other;
a charge accumulation time setting unit that sets, for an image that is formed by the imaging unit, a first charge accumulation time with which no flicker element is generated due to a power supply frequency of illumination and a second charge accumulation time different from the first charge accumulation time;
a switch unit that switches, for every frame, a charge accumulation time for the first group of pixels and a charge accumulation time for the second group of pixels between the first charge accumulation time and the second charge accumulation time;
a drive unit that drives the pixels included in the first group and the pixels included in the second group with the first charge accumulation time and the second charge accumulation time that are switched for every frame by the switch unit;
a signal switching unit that outputs an image signal obtained with the first charge accumulation time by the imaging unit as a first image signal, and outputs an image signal obtained with the second charge accumulation time by the imaging unit as a second image signal;
a first gain correction unit that performs gain correction to adjust a signal level of the first image signal to a signal level of the second image signal;
a gain calculation unit that calculates a gain correction coefficient for correcting a flicker element included in the second image signal based on the first image signal and the second image signal;
a second gain correction unit that corrects a flicker element included in the second image signal based on the gain correction coefficient; and
a signal combining unit that combines the second image signal corrected by the second gain correction unit and the first image signal subjected to gain correction performed by the first gain correction unit in an arrangement identical to an arrangement of the first group of pixels and the second group of pixels in the image sensor.

2. The imaging apparatus according to claim 1,
wherein the gain calculation unit calculates an average value A of signal levels in every horizontal line of a first image that is formed using the first image signal, and an average value B of signal levels in every horizontal line of a second image that is formed using the second image signal, and calculates a ratio C of the horizontal line average values as C=A/B as the gain correction coefficient, and
the second gain correction unit corrects the second image signal by multiplying the second image signal by the ratio C of the horizontal line average values calculated by the gain calculation unit.

3. The imaging apparatus according to claim 1,
wherein the imaging unit includes the image sensor in which the pixels included in the first group and the pixels included in the second group are arranged adjacent to each another in vertical and horizontal directions on an imaging surface of the image sensor.

4. The imaging apparatus according to claim 1,
wherein the imaging unit includes the image sensor in which the pixels included in the first group and the pixels included in the second group are arranged adjacent to each another in a vertical direction on an imaging surface of the image sensor.

5. The imaging apparatus according to claim 1,
wherein the imaging unit includes the image sensor in which the pixels included in the first group and the pixels included in the second group are arranged adjacent to each another in a horizontal direction on an imaging surface of the image sensor.

6. The imaging apparatus according to claim 1,
wherein the charge accumulation time setting unit sets the first charge accumulation time at n/100 second, where n is a natural number, when the power supply frequency of illumination is 50 Hz, and sets the first charge accumulation time at n/120 second, where n is a natural number, when the power supply frequency of illumination is 60 Hz.

7. An imaging method that is used in an imaging apparatus including an imaging unit whose image sensor has a first group of pixels and a second group of pixels that are driven independently of each other, the method comprising:
setting, for an image that is formed by the imaging unit, a first charge accumulation time with which no flicker element is generated due to a power supply frequency of illumination and a second charge accumulation time different from the first charge accumulation time;
switching, for every frame, a charge accumulation time for the first group of pixels and a charge accumulation time for the second group of pixels between the first charge accumulation time and the second charge accumulation time;
driving the pixels included in the first group and the pixels included in the second group with the first charge accumulation time and the second charge accumulation time that are switched for every frame in the switch step;
outputting an image signal obtained with the first charge accumulation time by the imaging unit as a first image signal, and outputting an image signal obtained with the second charge accumulation time by the imaging unit as a second image signal;
performing gain correction to adjust a signal level of the first image signal to a signal level of the second image signal;
calculating a gain correction coefficient for correcting a flicker element included in the second image signal based on the first image signal and the second image signal;
correcting a flicker element included in the second image signal based on the gain correction coefficient; and
combining the second image signal corrected in the second gain correction step and the first image signal subjected to gain correction performed in the first gain correction step in an arrangement identical to an arrangement of the first group of pixels and the second group of pixels in the image sensor.

8. A storage medium storing a computer-readable program that is used in an imaging apparatus including an imaging unit whose image sensor has a first group of pixels and a second group of pixels that are driven independently of each other, the program enabling a computer to function as:
a charge accumulation time setting unit that sets, for an image that is formed by the imaging unit, a first charge accumulation time with which no flicker element is generated due to a power supply frequency of illumination and a second charge accumulation time different from the first charge accumulation time;
a switch unit that switches, for every frame, a charge accumulation time for the first group of pixels and a charge accumulation time for the second group of pixels between the first charge accumulation time and the second charge accumulation time;
a drive unit that drives the pixels included in the first group and the pixels included in the second group with the first charge accumulation time and the second charge accumulation time that are switched for every frame by the switch unit;
a signal switching unit that outputs an image signal obtained with the first charge accumulation time by the imaging unit as a first image signal, and outputs an image signal obtained with the second charge accumulation time by the imaging unit as a second image signal;
a first gain correction unit that performs gain correction to adjust a signal level of the first image signal to a signal level of the second image signal;
a gain calculation unit that calculates a gain correction coefficient for correcting a flicker element included in the second image signal based on the first image signal and the second image signal;
a second gain correction unit that corrects a flicker element included in the second image signal based on the gain correction coefficient; and
a signal combining unit that combines the second image signal corrected by the second gain correction unit and the first image signal subjected to gain correction performed by the first gain correction unit in an arrangement identical to an arrangement of the first group of pixels and the second group of pixels in the image sensor.

9. An integrated circuit, comprising:
an imaging unit including an image sensor having a first group of pixels and a second group of pixels that are driven independently of each other;
a charge accumulation time setting unit that sets, for an image that is formed by the imaging unit, a first charge accumulation time with which no flicker element is generated due to a power supply frequency of illumination and a second charge accumulation time different from the first charge accumulation time;
a switch unit that switches, for every frame, a charge accumulation time for the first group of pixels and a charge accumulation time for the second group of pixels between the first charge accumulation time and the second charge accumulation time;
a drive unit that drives the pixels included in the first group and the pixels included in the second group with the first charge accumulation time and the second charge accumulation time that are switched for every frame by the switch unit;
a signal switching unit that outputs an image signal obtained with the first charge accumulation time by the imaging unit as a first image signal, and outputs an image signal obtained with the second charge accumulation time by the imaging unit as a second image signal;
a first gain correction unit that performs gain correction to adjust a signal level of the first image signal to a signal level of the second image signal;
a gain calculation unit that calculates a gain correction coefficient for correcting a flicker element included in the second image signal based on the first image signal and the second image signal;
a second gain correction unit that corrects a flicker element included in the second image signal based on the gain correction coefficient; and
a signal combining unit that combines the second image signal corrected by the second gain correction unit and the first image signal subjected to gain correction performed by the first gain correction unit in an arrangement identical to an arrangement of the first group of pixels and the second group of pixels in the image sensor.

10. An integrated circuit that is used in an imaging apparatus including an imaging unit whose image sensor has a first group of pixels and a second group of pixels that are driven independently of each other, the integrated circuit comprising:
a charge accumulation time setting unit that sets, for an image that is formed by the imaging unit, a first charge accumulation time with which no flicker element is generated due to a power supply frequency of illumination and a second charge accumulation time different from the first charge accumulation time;
a switch unit that switches, for every frame, a charge accumulation time for the first group of pixels and a charge accumulation time for the second group of pixels between the first charge accumulation time and the second charge accumulation time;
a drive unit that drives the pixels included in the first group and the pixels included in the second group with the first charge accumulation time and the second charge accumulation time that are switched for every frame by the switch unit;
a signal switching unit that outputs an image signal obtained with the first charge accumulation time by the imaging unit as a first image signal, and outputs an image signal obtained with the second charge accumulation time by the imaging unit as a second image signal;
a first gain correction unit that performs gain correction to adjust a signal level of the first image signal to a signal level of the second image signal;
a gain calculation unit that calculates a gain correction coefficient for correcting a flicker element included in the second image signal based on the first image signal and the second image signal;
a second gain correction unit that corrects a flicker element included in the second image signal based on the gain correction coefficient; and
a signal combining unit that combines the second image signal corrected by the second gain correction unit and the first image signal subjected to gain correction performed by the first gain correction unit in an arrangement identical to an arrangement of the first group of pixels and the second group of pixels in the image sensor.
